(19) United States
(12) Patent Application Publication
(10) Pub. No.: US 2011/0168726 A1
(43) Pub. Date: Jul. 14, 2011

(54) HYBRID PRESSURE VESSELS FOR HIGH PRESSURE APPLICATIONS

(75) Inventors: Pedro Alexandre Queirós Oliveira Silva Vieira, Matosinhos (PT); José Adelino Pessoa Santos, Guimaraes (PT); José Manuel Castro Fernandes Portocarrero, Macieira Da Maia (PT)

(73) Assignee: AMTROL Licensing Inc., West Warwick, RI (US)

(21) Appl. No.: 13/070,971

(22) Filed: Mar. 24, 2011

Related U.S. Application Data
(63) Continuation-in-part of application No. 13/034,362, filed on Feb. 24, 2011.
Application No. 13/034,362 is a continuation-in-part of application No. 12/761,955, filed on Apr. 16, 2010, now Pat. No. 7,935,206.
Application No. 12/761,955 is a division of application No. 11/540,189, filed on Sep. 29, 2006, now Pat. No. 7,699,188.
Application No. 11/540,189 is a continuation-in-part of application No. 11/115,992, filed on Apr. 25, 2005, now Pat. No. 7,255,245.
Application No. 11/540,189 is a continuation-in-part of application No. 29/259,834, filed on May 16, 2006, now Pat. No. D566807.
(60) Provisional application No. 60/564,776, filed on Apr. 23, 2004.

(51) Int. Cl. F17C 1/06

(52) U.S. Cl. 220/590

(57) ABSTRACT

A pressure vessel is provided including an inner tank formed from a tank liner surrounded by a wound layer of composite filaments. A protective jacket is disposed on the inner tank that facilitates stacking and portability of the pressure vessel and helps to define an air passage for convective heat transfer between the hybrid tank and the environment.

### CROSS-REFERENCE TO RELATED APPLICATIONS

This application is a continuation in part of U.S. patent application Ser. No. 13/034,362 filed Feb. 24, 2011. This application is also a continuation in part of U.S. patent application Ser. No. 12/761,955 filed Apr. 16, 2010. Said U.S. patent application Ser. No. 12/761,955 is a divisional of U.S. patent application Ser. No. 11/540,189, filed Sep. 29, 2006, now U.S. Pat. No. 7,699,188 granted Apr. 20, 2010, which claims the benefit of priority from U.S. patent application Ser. No. 29/259,834, filed May 16, 2006, now U.S. Pat. No. D566,807 granted Apr. 15, 2008, and U.S. patent application Ser. No. 11/115,992, filed Apr. 25, 2005, now U.S. Pat. No. 7,255,245 granted Aug. 14, 2007, which claims priority from U.S. Provisional Patent Application Ser. No. 60/564,776, filed Apr. 23, 2004. The disclosures of each of the above-referenced applications and patents are hereby incorporated by reference herein in their entireties.

### BACKGROUND OF THE INVENTION

1. Field of the Invention

The subject invention is directed to pressure vessels, and particularly to a pressure vessel having a hybrid tank foamed of a tank liner and outer composite layer with a protective jacket disposed thereon.

2. Background of the Related Art

Pressure vessels come in all sizes and shapes, and are made from a variety of materials. The need for lightweight pressure vessels has existed and still exists. There have been many attempts to make light weight pressure vessels that are able to store fluids under high pressures for long periods of time, maintain structural integrity, sustain repeated pressurization and depressurization, and be substantially impermeable, resistant to corrosion, and easy to manufacture.

Increased use of alternative fuels, such as compressed natural gas and hydrogen to fuel vehicles, and the need for ever greater fuel range has increased the need for lightweight, safe tanks with greater capacity and strength. Increasing the capacity and strength of a pressure vessel can be achieved by increasing the amount of materials used for structural support. However, this can result in a significant increase in the size and/or weight of the pressure vessel, which can increase the cost of the tank arising from increased material costs and costs associated with transporting the heavier pressure vessels.

Clearly, there is a need in the art for a lightweight pressure vessel that is impermeable, corrosion resistant and that can handle increased capacity and pressure demands. Furthermore, there is a need for a method of forming such a pressure vessel so it may be sold at a competitive price.

### SUMMARY OF THE INVENTION

The subject invention provides a pressure vessel which satisfies the aforementioned needs in the art. In particular, the present invention provides a pressure vessel that includes a hybrid tank formed by a tank liner and an outer reinforcing layer disposed on the tank liner, with the outer reinforcing layer defining at least a portion of an outer surface of the hybrid tank. A protective jacket configured and dimensioned to engage the hybrid tank is disposed thereon. The protective jacket includes an upper support rim having a first opening therethrough, a lower support rim having a second opening therethrough, and a substantially cylindrical wall connecting the upper support rim and lower support rim. The wall defines an inner surface disposed radially outwardly from the outer surface of the hybrid tank, and the inner surface of the wall and the outer surface of the hybrid tank cooperate to define a flow channel in fluid communication with the first opening and the second opening, wherein the openings and flow channel are adapted to permit a convective flow to pass therethrough to facilitate heat transfer between the hybrid tank and an environment in which the pressure vessel is situated. The protective jacket is preferably separable into at least two sections.

In accordance with a further embodiment of the invention, the tank liner may include a material having a higher modulus of elasticity and a lower elastic strain limit than the outer reinforcing layer. If desired, the outer reinforcing layer can be fabricated of a thermoplastic material, preferably polypropylene, comingled with glass fibers. Preferably the hybrid tank includes an outer anti-corrosion coating. If desired, the outer reinforcing layer can include an outer gel coating.

In accordance with another embodiment of the invention, the upper support rim includes at least one handle and the lower support rim includes a base configured and adapted to form a non-permanent mating engagement with the at least one handle of another pressure vessel when stacking multiple pressure vessels.

The present invention also provides a method of manufacturing a pressure vessel. The method includes forming a tank liner, heating glass filaments, comingling the filaments with a thermoplastic material and winding the thermoplastic material and comingled filaments onto the tank liner under application of heat to form a hybrid tank having an outer surface.

In further accordance with the invention, the method further can include the step of attaching a protective jacket to the hybrid tank, where the protective jacket includes an upper support rim having a first opening therethrough, a lower support rim having a second opening therethrough, and a substantially cylindrical wall connecting the upper support rim to the lower support rim. The wall defines an inner surface disposed radially outwardly from the outer surface of the hybrid tank, and the inner surface of the wall and the outer surface of the hybrid tank cooperate to define a flow channel in fluid communication with the first opening and the second opening, wherein the openings and flow channel are adapted to permit a convective flow to pass therethrough to facilitate heat transfer between the hybrid tank and an environment in which the pressure vessel is situated.

The invention also provides a hybrid tank for a high pressure vessel. The hybrid tank includes a metallic tank liner having opposed first and second end regions with a central circumferential region therebetween. The hybrid tank also includes an outer reinforcing layer disposed on an exterior portion of the tank liner.

In certain embodiments, each of the outer reinforcing layer and the tank liner has a wall thickness normal to an exterior surface of the tank liner, wherein the ratio of the wall thickness of the outer reinforcing layer to the wall thickness of the tank liner is at least 4.0 over a majority of the exterior portion of the tank liner. It is contemplated that the wall thickness of the tank liner can be substantially constant. The wall thickness of the outer reinforcing layer can vary from a local maximum wall thickness proximate the central circumferential region of the tank liner to a minimum wall thickness proximate each of the first and second end regions of the tank liner. The ratio of the local maximum wall thickness of the outer reinforcing layer proximate the central circumferential region to the wall thickness of the tank liner can be at least 5.0. A region having the minimum wall thickness of the outer reinforcing layer can be proximate a domed portion of each end region of the tank liner.

The outer reinforcing layer can include a fiber-epoxy composite material including at least one type of fiber selected from the group consisting of carbon fiber, basalt fiber, aramid fiber, para-aramid synthetic fiber, and/or any other suitable type of fiber. The hybrid tank can include a protective jacket engaged around the outer reinforcing layer to protect the outer reinforcing layer. The protective jacket can include an upper support rim, a lower support rim opposed to the upper support rim, and a jacket wall connecting the upper support rim to the lower support rim.

In certain embodiments, the tank liner includes opposed dome shaped first and second endcaps each secured to the central circumferential region of the tank liner by a weld, which can be a laser weld, submerged arc weld, GMAW arc weld, or any other suitable type of weld. The opposed dome shaped first and second endcaps can be secured directly to each other by a laser weld. It is also contemplated that the tank liner can include a substantially cylindrical tube defining first and second rims wherein the opposed dome shaped first and second endcaps are secured to the first and second rims of the tube by laser welds.

The tank liner can include a material having a lower modulus of elasticity than a fiber component of the outer reinforcing layer. The tank liner material can have a higher elastic strain limit that a fiber-epoxy composite material of the outer reinforcing layer. The tank liner can include a metal selected from the group consisting of steel, stainless steel, or any other suitable material.

The invention also provides a method of manufacturing a hybrid tank for a high pressure vessel. The method includes forming a metallic tank liner having opposed first and second end regions with a central circumferential region therebetween and forming an outer reinforcing layer disposed on an exterior portion of the tank liner. The step of forming a metallic tank liner can include welding tank liner components together, such as dome shaped endcaps and/or a substantially cylindrical tube as described above. The welding can be laser welding or any other suitable type of welding. The step of forming an outer reinforcing layer can include forming the outer reinforcing layer to achieve wall thickness ratios as described above. It is also contemplated that the method can include engaging a protective jacket as described above around the outer reinforcing layer.

These and other aspects of the pressure vessel of the subject invention will become more readily apparent to those having ordinary skill in the art from the following detailed description of the invention taken in conjunction with the drawings.

### BRIEF DESCRIPTION OF THE DRAWINGS

So that those having ordinary skill in the art to which the present invention pertains will more readily understand how to make and use the pressure vessel of the present invention, embodiments thereof will be described in detail hereinbelow with reference to the drawings, wherein:

FIG. 1 is a perspective view of a pressure vessel constructed in accordance with a preferred embodiment of the subject invention as seen from above, showing openings in the upper support rim of the protective jacket, as well as a valve fitting assembly, and handles on the upper support rim;

FIG. 2 is a perspective view of the pressure vessel shown in FIG. 1, as seen from below, showing the lower support rim of the protective jacket, as well as openings therethrough;

FIG. 3 is a top view of the pressure vessel shown in FIG. 1, depicting openings in the upper support rim to facilitate airflow through the protective jacket and further depicting handles on the upper support rim adapted and configured to allow access to the valve fitting assembly;

FIG. 4 is a bottom view of the pressure vessel shown in FIG. 1, showing openings in the lower support rim for airflow into and out of the protective jacket;

FIG. 5 is an exploded perspective view of the pressure vessel shown in FIG. 1;

FIG. 6 is a partial cross-section view of the hybrid tank of the pressure vessel shown in FIG. 5, depicting layers of material of the hybrid tank;

FIG. 7 is a partial cross-section view of the lower support rim of the protective jacket of the pressure vessel shown in FIG. 5;

FIG. 8 is a partial cross-section view of the padding and lower support rim of the pressure vessel shown in FIG. 5;

FIG. 9 is a partial cross-section view of an protective jacket and hybrid tank of the assembled pressure vessel shown in FIG. 1, showing the channel for flow of air between the hybrid tank and the protective jacket;

FIG. 10 is a partial cut away perspective view of the pressure vessel shown in FIG. 1, showing how the flow of air can pass trough the openings in the upper support rim and into the space between the hybrid tank and the protective jacket;

FIG. 11 is a partial cross-section view of the assembled pressure vessel shown in FIG. 2, showing how the flow of air can pass trough the openings in the lower support rim, past the padding, and into the space between the hybrid tank and the protective jacket;

FIG. 12 is a side view showing two pressure vessels as depicted in FIG. 1 in a nested configuration;

FIG. 13 is a partial cross-sectional elevation view of an exemplary embodiment of a hybrid tank constructed in accordance with the subject invention, showing the welded tank liner and the outer reinforcing layer disposed thereon;

FIG. 14 is a cross-sectional elevation view of the portion of the hybrid tank indicated in FIG. 13, showing the wall thicknesses of the tank liner and outer reinforcing layer proximate the dome shaped end of the hybrid tank; and

FIG. 15 is a partial cross-sectional elevation view of a portion of the hybrid tank of FIG. 13, showing the tank liner without the outer reinforcing layer disposed thereon.

### DETAILED DESCRIPTION OF PREFERRED EMBODIMENTS

Reference will now be made in detail to the present preferred embodiments of the invention, examples of which are illustrated in the accompanying drawings. The method and corresponding steps of the invention will also be described in conjunction with the detailed description of the system.

The pressure vessels presented herein, and the products of the methods presented herein, may be used for storing pressurized fluids. The present invention is particularly suited for storing and dispensing pressurized fluids while facilitating stacking and portability of the pressure vessel. A pressure vessel constructed in accordance with the present invention is suitable for applications including, but not limited to, storing propane, refrigerant gas, and liquids or gases at low or high pressure.

In accordance with the invention, a pressure vessel is provided including a hybrid tank having an inner liner and an outer reinforcing layer, and a protective jacket adapted to surround the hybrid tank. The protective jacket includes an upper support rim having an opening therethrough and a lower support rim having a second opening therethrough. The protective jacket also includes a substantially cylindrical wall spaced apart from the hybrid tank to allow a convective flow between the protective jacket and the hybrid tank for convective heat transfer between the pressure vessel and the environment to reduce pressure loss during consumption of the pressurized contents.

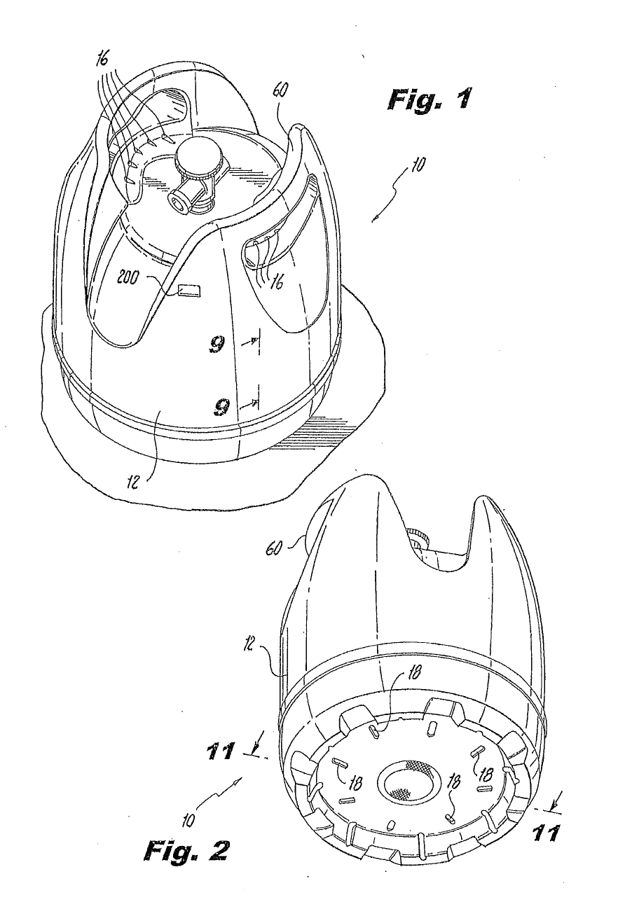

For purpose of explanation and illustration, and not limitation, a view of an exemplary embodiment of a pressure vessel made in accordance with the present invention is depicted in FIG. 1 and is designated generally by reference number 10. Other aspects of the pressure vessel depicted in FIG. 1 are depicted in FIGS. 2-12, as will be described.

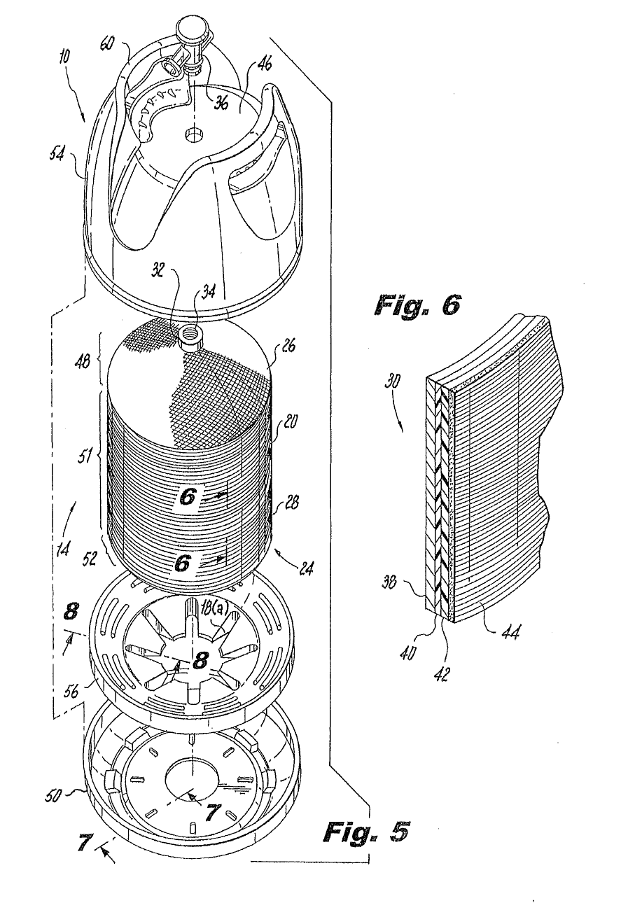

For purposes of illustration and not limitation, as embodied herein and as depicted in FIGS. 1-12, a pressure vessel 10 is provided with a hybrid tank 14. Hybrid tank 14 has a tank liner 38 that may be formed from a generally cylindrical tube 20 and first and second dome-shaped, semi-hemispherical endcaps 22 and 24. Endcaps 22 and 24 may be of any size or shape, such as frustro-conical or flattened, and may be identical or different. First and second endcaps 22 and 24 are secured to first and second end rims 26 and 28 of tube 20, respectively, which may be accomplished by any conventional welding techniques known in the art, such as laser welding. Tube 20 and first and second endcaps 22 and 24 cooperate to define vessel storage cavity 30, as particularly depicted in FIGS. 6 and 9.

As depicted, first endcap 22 includes a central aperture 32 defined therein for receiving a valve boss 34, which is secured to aperture 32 by any conventional welding or other suitable joining techniques as are known in the art. Valve boss 34 is configured to receive a valve fitting assembly 36 therein, and the combination permits the ingress or egress of fluids to vessel storage cavity 30.

If desired, the tank liner 38 may be constructed without the tube 20. In accordance with this alternative embodiment, endcaps 22 and 24 are joined directly to each other rather than to the tube 20. As such, endcaps 22, 24 may take on a variety of shapes, and need not be generally hemispherical, but can be more “cup” shaped, as desired, as will be appreciated by those of skill in the art.

Preferably, tank liner 38 including tube 20, first and second endcaps 22 and 24, and valve boss 34 are constructed of an inert, impermeable and non-corrosive material having a high modulus of elasticity, such as 10 million psi or greater, and a low elastic strain generally ranging from about 0.05% to about 1%. As such, the tank liner 38 and valve fitting assembly 36 may be made from steel, but may also be fabricated of metals such as, but not limited to, stainless steel, aluminum, nickel, titanium, platinum, or any other material which would provide suitable structural support in accordance with the present invention. It is also within the scope and spirit of the invention to fabricate the tank liner 38 from polymeric materials.

In further accordance with the invention, a hybrid tank is further provided including an outer reinforcing layer.

For purposes of illustration and not limitation, as embodied herein and as depicted in FIG. 6, a cross section of a wall section of hybrid tank 14 is depicted. As shown in FIG. 6, an outer reinforcing layer 42 is disposed about the tank liner 38. Reinforcing layer 42 is fabricated of one or more layers of a material having a higher elastic strain limit than that of the material used for the tank liner 38, as described in further detail below. Preferably, an anti-corrosive coating 40 is applied to the outside of the tank liner 38 before disposing the reinforcing layer 42 on the tank liner. This can be particularly advantageous where the tank liner 38 is fabricated from metal. As such, the anti-corrosive coating 40 helps prevent corrosion between the tank liner 38 and the reinforcing layer 42, which could otherwise weaken the hybrid tank 14. The anticorrosive coating can be composed of a variety of materials, including zinc rich primers and other anti-corrosive coatings as are known in the art. The anti-corrosive coating can be applied, for example, by spraying a powder coating on the tank liner 38, followed by heating to set the power coat. Other methods of applying the anti-corrosive coating are also possible and within the scope of the invention. Preferably, the anti-corrosive coating 40 is applied to the entire outward surface of the tank liner 38.

Reinforcing layer 42 may include a composite material having a skeleton that imparts desirable mechanical properties to the composite, such as a high tensile strength, and a matrix of material having high ductility that can bind the composite to render it stiff and rigid, among other things. Reinforcing layer 42 reinforces and provides impact resistance to hybrid tank 14. The outer surface of reinforcing layer 42 preferably includes a protective layer 44 comprised of a gel coating, for example or other finishing coatings to protect the reinforcing layer 42. Suitable materials for forming protective layer 44 include, for example, thermoplastic modified polyolefin powder, applied, for example, by spraying techniques and consequent heating to set, and the like.

Preferably, the composite material in reinforcing layer 42 consists of fibers or filaments that are comingled or impregnated with a thermoplastic or thermoset resin. The impregnated filaments may include, but are not limited to, combinations of glass, metal, aramid, carbon, graphite, boron, synthetics, resins, epoxies, polyamides, polyoelfins, silicones, and polyurethanes, among other things. Preferably, the filaments are a composite of thermoplastic or thermoset resin, such as vinyl epoxy or polypropylene, and glass fiber. The filaments can be formed from a comingled thermoplastic and glass fiber fabric sold as TWINTEX, commercially available from Saint-Gobain Vetrotex America Inc. Preferably, the composite material used in reinforcing layer 42 is a recyclable material.

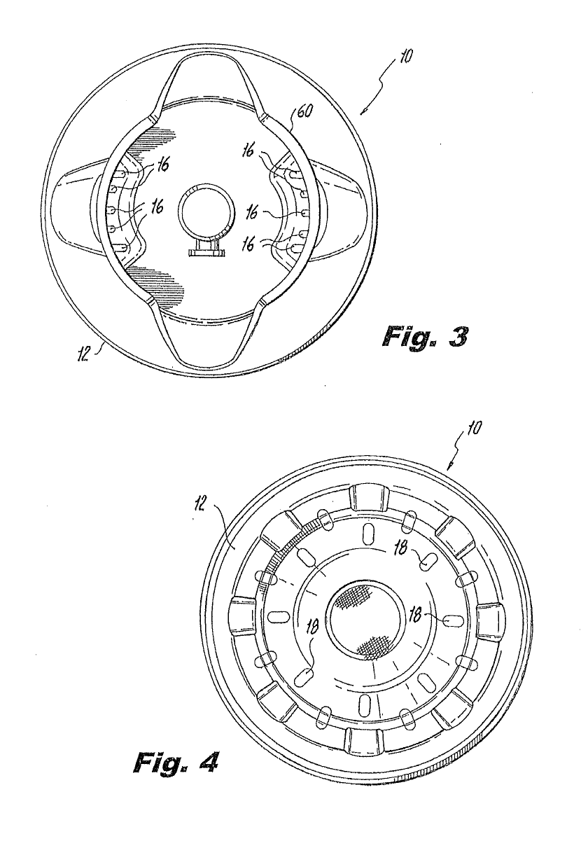

In further accordance with the invention, the pressure vessel includes a protective jacket. For purposes of illustration, and not limitation, as depicted in FIGS. 1-5, protective jacket 12 surrounds the hybrid tank 14. Protective jacket 12 has an upper support rim 46, and a lower support rim 50, and a substantially cylindrical wall 54 between the upper support rim 46 and lower support rim 50. Upper support rim 46 is disposed substantially about the periphery of an upper portion 48 of the hybrid tank 14 and a lower support rim 50 is disposed substantially about the periphery of a lower portion 52 of the hybrid tank 14. FIGS. 1 and 3 depict upper airflow openings 16 in the upper support rim 46. FIGS. 2 and 4 depict lower airflow openings 18 in the lower support rim 50. Upper airflow openings 16 and lower airflow openings 18 allow air to flow to and from outside to facilitate heat transfer between the environment and the pressurized contents of the hybrid tank 14, discussed in detail below. Upper and lower support rims 46 and 50 are preferably configured to engage the hybrid tank 14 to restrict movement of the hybrid tank 14 within the confines of protective jacket 12. Movement is further restricted by the shock absorbing padding 56 in the lower support rim 50 disposed between protective jacket 12 and hybrid tank 14. Padding 56 can be made from a variety of materials, including expanded polypropylene, among others.

Protective jacket 12 is preferably constructed of a rigid, lightweight material, such as a hard plastic, such as polypropylene or high density polyethylene, or other suitable materials. In this configuration, the protective jacket 12 can protect the hybrid tank 14 from impacts, abrasions, and exposure to corrosive materials, among other things.

It is known in the art that the consumption of gas from a pressurized vessel causes cooling of the pressurized vessel. This cooling can reach an extent to which the liquefied gas can no longer evaporate at an adequate rate. In this situation, there will be a pressure loss that hinders evacuation from the pressurized vessel. The transfer of heat from the ambient environment in which the pressure vessel is situated to the contents of the pressure vessel therefore should be facilitated to maintain the pressure of the contents of the pressure vessel during gas consumption. However, adding protective jackets to pressure vessels generally results in adding material between the pressurized contents and the environment. As such, protective jackets tend to insulate pressurized contents, hinder heat exchange, and ultimately promote the undesirable pressure loss during gas consumption. It is therefore desirable to minimize the insulative effects of protective jackets.

It is known it the art to provide a jacket for an all-metal pressure tank in which wave-like undulations fall led in the wall of a jacket provide channels for convective air flows, such as in U.S. Pat. No. 6,386,384, which is incorporated herein by reference in its entirety. These wave-like channels function well in providing for heat transfer in the case of all-metal tanks as found in the art, but a fiber-composite/metal embodiment of hybrid tank 14 creates a need for further advances to enhance the convective flow, since the composite reinforcing layer 42 provides more thermal insulation than is present in the all-metal tanks of the prior art.

Therefore, the configuration of protective jacket 12 permits for enhanced flow that may substantially surround the circumference of the hybrid tank 14. This is an advance over the art because heat exchange takes place along a greater surface area than allowed for in the wave-like channels known in the art. This enhancement to the flow and surface area of the convective heat exchange helps compensate for the increased thermal insulation of the hybrid tank 14 as contrasted with the all-metal tanks of the prior art.

To this end, the present invention facilitates downward natural convective flows between the protective jacket 12 and the hybrid tank 14 to gain the advantages of the protective jacket while minimizing the loss of pressure due to inadequate heat exchange. The substantially cylindrical wall 54 of protective jacket 12 is disposed around a middle portion 51 of hybrid tank 14. As shown in FIG. 9, the inner surface of the substantially cylindrical wall 54 is spaced apart from the outer surface of the hybrid tank 14 to allow a generally downward vertical flow of air to develop between the hybrid tank 14 and the protective jacket 12. There is thus a generally annular flow channel 58 defined between the hybrid tank 14 and the protective jacket 12 in fluid communication with the environment in which the pressure vessel 10 is located.

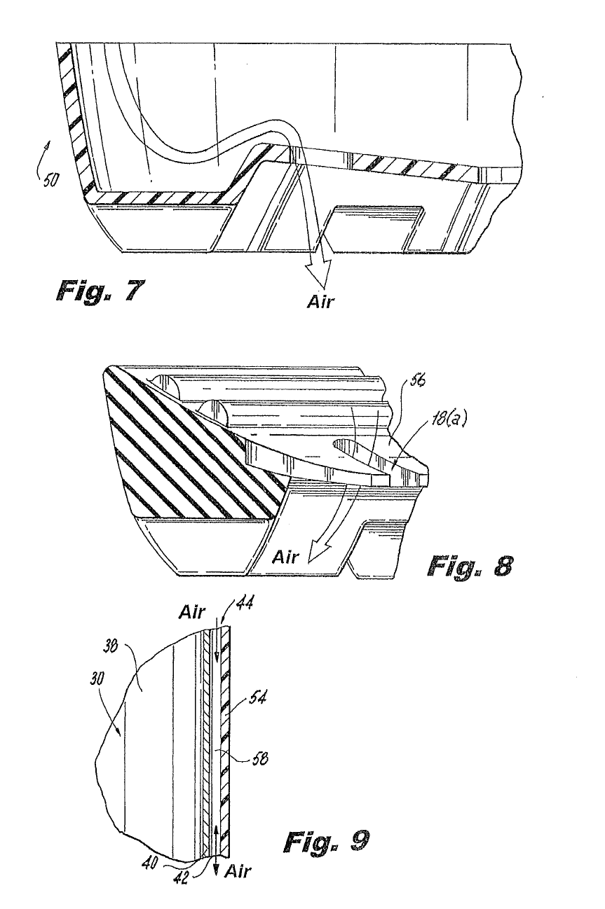

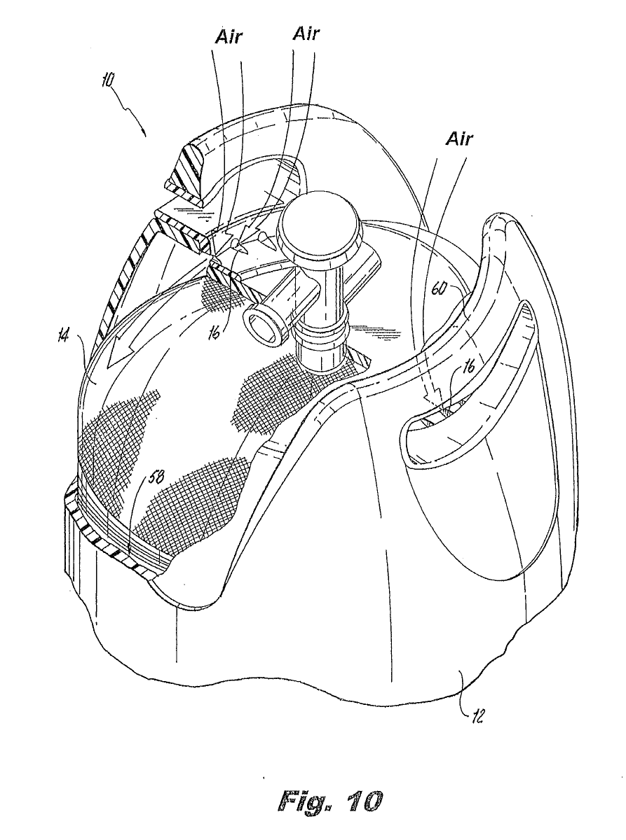

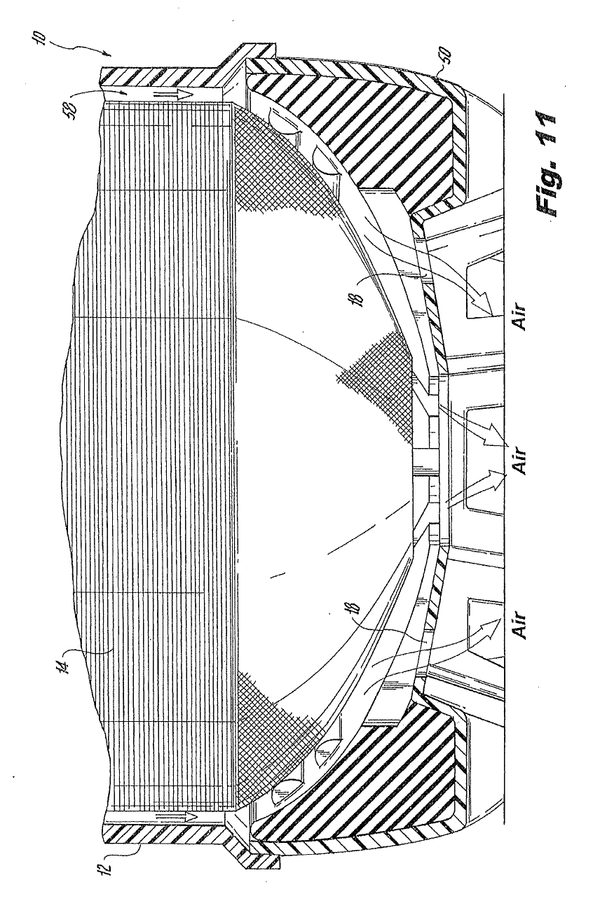

FIG. 10 shows how air can communicate from outside the pressure vessel 10, through the upper openings 16, down into the annular flow channel 58 and out through lower openings 18. In particular, FIGS. 7, 8, and 11 show how air can communicate from the substantially annular flow channel 58 inside the pressure vessel 10, past openings 18(a) in the padding 56 (FIG. 5), through the lower openings 18, and into the environment. The ability of air to flow from upper openings 16, through the annular flow channel 58, and out the lower openings 18 permits natural convection flows to develop along the whole circumference of the annular flow channel 58, and thus gives the pressure vessel an enhanced ability to exchange heat between the hybrid tank 14 and the environment, while also having the added durability afforded by the protective jacket 12.

In another aspect of a preferred embodiment of the invention, the upper support rim 46 includes at least one handle 60 configured to permit access to valve fitting assembly 36, as shown in FIGS. 1-3. Preferably, handle 60 is ergonomically designed to assist transport of pressure vessel 10.

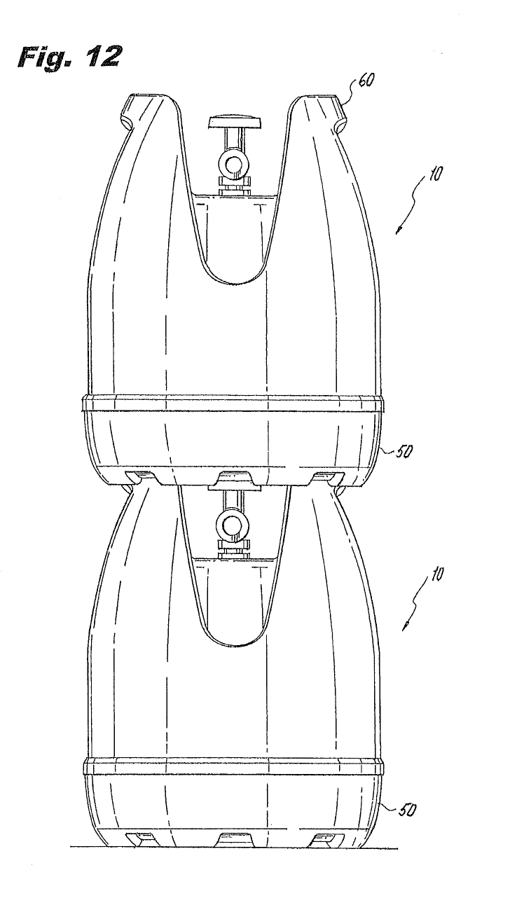

By way of further example, for purposes of illustration only, as shown in FIG. 12, handle 60 and lower support rim 50 are preferably configured to engage one another to facilitate transporting and stacking a plurality of pressure vessels 10. In this embodiment, handles 60 are curved and configured to form a non-permanent mating engagement with lower support rim 50, which is configured to receive the handles 60, when stacking multiple pressure vessels 10.

In accordance with another embodiment of the invention, a pressure vessel can be provided further including a means for uniquely identifying each tank. For purposes of illustration only, and not limitation, an identification means, such as a radio frequency identification tag, microchip and/or barcode 200 (FIG. 1) can be provided to uniquely identify each pressure vessel. During manufacture, a database can be maintained for uniquely identifying and tracking each cylinder after the cylinder leaves the manufacturing facility. A variety of variables can be tracked for each cylinder by the manufacturer, such as the tare weight, retest date, manufacturing date, batch or lot numbers, and the like.

In accordance with another aspect of the invention, a method for manufacturing a pressure vessel is provided. For purposes of illustration only, and not limitation, the method preferably includes forming a tank liner (such as tank liner 38), heating glass filaments, comingling the filaments with a thermoplastic material, winding the thermoplastic material and comingled filaments onto the tank liner 38 under application of heat to form a hybrid tank 14, and attaching a protective jacket 12 to the hybrid tank 14 to create the substantially annular flow channel 58 as described herein.

By way of further example, the method can further include a step of applying an anti-corrosion coating to the outside of the tank liner 38 before winding the thermoplastic material and comingled filaments onto the tank liner 38. This anti-corrosion coating 40 can reduce corrosion between the tank liner 38 and outer reinforcing layer 42 in the case of a metal tank liner 38.

The winding step can include rotating the tank liner on a mandrel while the filaments are wound onto the tank liner, as is known in the art. The winding may be done continuously with a single filament comprising the outer reinforcing layer 42 of hybrid tank 14. In further accordance with the method of the invention, it is also possible to comingle the filaments with polypropylene as the thermoplastic material. The method may further include applying a final outer gel coating 44 over the outer reinforcing layer 42, as is known in the art.

In further accordance with the method of the invention, it is possible for the protective jacket 12 to be attached to the hybrid tank 14 by having the protective jacket be separable into at least two sections that attach together with clipping systems as is known in the art. The sections can be separable along a circumference of the generally cylindrical wall 54 of protective jacket 54, as shown in FIG. 5. Or the sections could be separable longitudinally or obliquely without departing from the spirit and scope of the invention. The sections of the jacket may be attached to one another by permanent or non-permanent engagement, as desired. For example, the sections of jacket 12 may be permanently attached to each other by welding, adhesive or fasteners. If desired, the connection between sections of jacket 12 may be non-permanent, such as by a snap fit connection.

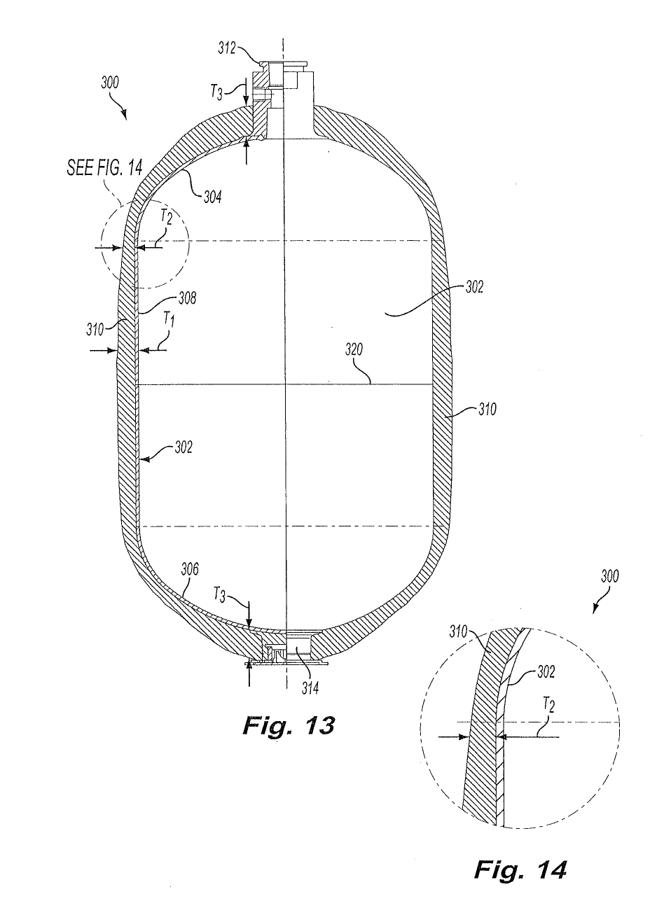

Referring now to FIGS. 13-15, the invention also provides a hybrid tank 300 for a high pressure vessel. Certain gas products, such as propane and refrigerant gas, are typically contained in low pressure gas cylinders, e.g., at pressures around 30-60 bar. However, there are gas products, such as shielding gases for welding, helium, nitrogen, carbon dioxide, etc., that are typically contained in high pressure gas cylinders, e.g., at pressures around 200-300 bar. Hybrid tank 300 is advantageously configured for such high pressure applications.

Hybrid tank 300 includes a metallic tank liner 302 having opposed first and second end regions 304 and 306 with a central circumferential region 308 therebetween. Hybrid tank 300 also includes an outer reinforcing layer 310 disposed on an exterior portion of tank liner 302.

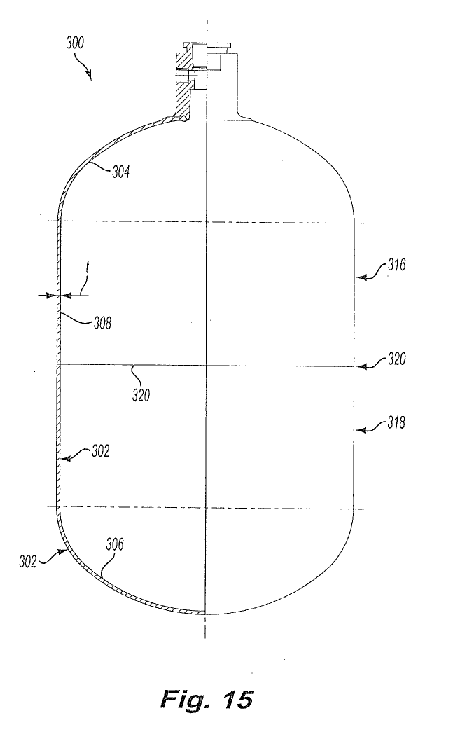

Tank liner 302 has a wall thickness t, indicated in FIG. 15, that is substantially constant as a function of location on tank liner 302, wherein thickness t is measured normal to the exterior surface of tank liner 302 at any given location thereon. Outer reinforcing layer 310 a wall thickness T that varies depending on location, wherein thickness T is similarly measured normal to the exterior surface of tank liner 302. Three exemplary wall thicknesses, T₁, T₂, and T₃ are indicated in FIG. 13 for different locations on outer reinforcing layer 310. The ratio of the wall thickness T of outer reinforcing layer 310 at any given location on hybrid tank 300 to the wall thickness of tank liner 302 is at least 4.0 over a majority of the exterior portion of the tank liner, i.e., T/t≧4.0. The wall thickness T of outer reinforcing layer 310 varies from a local maximum wall thickness T₁ proximate the central circumferential region 308 of the tank liner to a minimum wall thickness T₂ proximate each of the first and second end regions 304 and 306 of the tank liner. The ratio of the local maximum wall thickness T₁ of outer reinforcing layer 310 proximate central circumferential region 308 to the wall thickness t of the tank liner is at least 5.0, i.e., T₁/t≧5.0. The region having the minimum wall thickness T₂ of outer reinforcing layer 310 is proximate a domed portion of each end region of tank liner 302, as shown in FIG. 14. At the top and bottom of hybrid tank 300 (as oriented in FIGS. 13-15), the wall thickness of outer reinforcing layer 310 is T₃, which is even greater than T₁ in order to strengthen the portions of hybrid tank 300 where valve boss 312 and base support 314 meet tank liner 302. The ratio of the wall thickness T₃ to the wall thickness t of the tank liner is at least 8.5, i.e., T₃/t≧8.5, which represents the maximum thickness of outer reinforcing layer 310.

Outer reinforcing layer 310 is made of a fiber-epoxy composite material including at least one type of fiber selected from the group consisting of carbon fiber, basalt fiber, aramid fiber, para-aramid synthetic fiber (e.g., Kevlar® fiber available from E.I. du Pont de Nemours and Company of Wilmington, Del.), or any other suitable type of high-strength fiber. The hybrid tank can include a protective jacket, as described above, engaged around the outer reinforcing layer to protect the outer reinforcing layer. The protective jacket can include an upper support rim, a lower support rim opposed to the upper support rim, and a jacket wall connecting the upper support rim to the lower support rim. For certain high pressure applications, heat exchange for hybrid tank 300 is not crucial. Therefore, it is possible to eliminate the flow features of the protective jackets described above for applications where such are not needed. It is, however, contemplated that to help dissipate heat during filling, hybrid tank 300 could be pre-cooled, such as when filling with permanent gasses, i.e., gases that do not liquefy under the operating pressures and temperatures of the pressure vessel.

Base support 314 passes through outer reinforcing layer 310 from the exterior thereof to the interior thereof, where base support contacts tank liner 302. Base support 314 is provided to close outer reinforcing layer 310, and can be made of metal or any other suitable material. A plastic outer attachment can optionally be included, to make it easier to apply labels, such as by laser processes.

Referring now to FIG. 15, tank liner 302 includes opposed dome shaped first and second endcaps 316 and 318 each secured to central circumferential region 308 of the tank liner by a weld 320, which can advantageously be a laser weld, submerged arc weld, GMAW (gas metal arc welding) weld, or any other suitable type of weld. The opposed dome shaped first and second endcaps 316 and 318 are secured directly to each other by weld 320. It is also contemplated that the tank liner can include a substantially cylindrical tube defining first and second rims wherein the opposed dome shaped first and second endcaps are secured to the first and second rims of the tube, as described above with respect to pressure vessel 10, by laser welds, or any other suitable type of weld as described above.

Tank liner 302 can be made of a material having a lower modulus of elasticity than the fiber component in the outer reinforcing layer, but higher than the overall modulus of elasticity of composite material of the outer reinforcing layer. Tank liner 302 can be made of a material having a higher elastic strain limit than the fiber material of the outer reinforcing layer, and higher than the elastic strain limit of the composite material of the outer reinforcing layer (e.g., steel can have a higher elastic strain limit generally ranging from about 10% to about 30%, depending on the type of steel used, whereas for carbon fibers the lower elastic strain limit generally ranges between about 1% and 2%, and for carbon fiber-epoxy composites the lower elastic strain limit can range generally from about 1% to about 2%). Suitable materials for tank liner 302 include metals such as steel, stainless steel, or any other suitable material.

Hybrid tank 300 can be constructed/manufactured by the following method in accordance with the subject invention. The method includes forming a metallic tank liner, e.g., tank liner 302, having opposed first and second end regions with a central circumferential region therebetween. The method also includes forming an outer reinforcing layer, e.g., outer reinforcing layer 310, disposed on an exterior portion of the tank liner. The step of forming a metallic tank liner can include welding tank liner components together, such as dome shaped endcaps and/or a substantially cylindrical tube as described above. The welding can be performed by laser welding or any other suitable type of welding. The step of forming an outer reinforcing layer can include forming the outer reinforcing layer to achieve wall thickness ratios as described above. It is also contemplated that the method can include engaging a protective jacket as described above around the outer reinforcing layer.

The methods and systems of the present invention, as described above and shown in the drawings, provide for pressure vessels with superior properties including high pressure capacity, ease of manufacture, light weight, ergonomics, stackability, resistance to corrosion and impact, and enhanced heat transfer. It will be apparent to those skilled in the art that various modifications and variations can be made in the device and method of the present invention without departing from the spirit or scope of the invention. Thus, it is intended that the present invention include modifications and variations that are within the scope of the appended claims and their equivalents.

What is claimed is:

1. A hybrid tank for a high pressure vessel, comprising:
a) a metallic tank liner having opposed first and second end regions with a central circumferential region therebetween; and
b) an outer reinforcing layer disposed on an exterior portion of the tank liner, wherein each of the outer reinforcing layer and the tank liner has a wall thickness normal to an exterior surface of the tank liner, wherein the ratio of the wall thickness of the outer reinforcing layer to the wall thickness of the tank liner is at least 4.0 over a majority of the exterior portion of the tank liner.

2. A hybrid tank as recited in claim 1, wherein the wall thickness of the tank liner is substantially constant.

3. A hybrid tank as recited in claim 1, wherein the wall thickness of the outer reinforcing layer varies from a local maximum wall thickness proximate the central circumferential region of the tank liner to a minimum wall thickness proximate each of the first and second end regions of the tank liner.

4. A hybrid tank as recited in claim 3, wherein the ratio of the local maximum wall thickness of the outer reinforcing layer proximate the central circumferential region to the wall thickness of the tank liner is at least 5.0.

5. A hybrid tank as recited in claim 3, wherein a region having the minimum wall thickness of the outer reinforcing layer is proximate a domed portion of each end region of the tank liner.

6. A hybrid tank as recited in claim 1, wherein the outer reinforcing layer includes a fiber-epoxy composite material including at least one type of fiber selected from the group consisting of carbon fiber, basalt fiber, aramid fiber, and para-aramid synthetic fiber.

7. A hybrid tank as recited in claim 1, wherein the tank liner includes opposed dome shaped first and second endcaps secured directly to each other by a type of weld selected from the group consisting of a laser weld, a GMAW weld, and a submerged arc weld.

8. A hybrid tank as recited in claim 1, wherein the tank liner includes a substantially cylindrical tube defining first and second rims and opposed dome shaped first and second endcaps secured to the first and second rims of the tube, respectively, by welds of a type selected from the group consisting of a laser weld, a GMAW weld, and a submerged arc weld.

9. A hybrid tank as recited in claim 1, further comprising a protective jacket engaged around the outer reinforcing layer to protect the outer reinforcing layer, the protective jacket including an upper support rim, a lower support rim opposed to the upper support rim, and a jacket wall connecting the upper support rim to the lower support rim.

10. A hybrid tank as recited in claim 1, wherein the outer reinforcing layer includes a fiber-epoxy composite having a fiber component and an epoxy component, and wherein the tank liner includes a material having a lower modulus of elasticity than the fiber component and a higher elastic strain limit than the fiber-epoxy composite.

11. A hybrid tank as recited in claim 1, wherein the tank liner includes a metal selected from the group consisting of steel, stainless steel, aluminum, platinum, and titanium.

12. A hybrid tank for a high pressure vessel, comprising:
a) a metallic tank liner having opposed first and second end regions with a central circumferential region therebetween, wherein the tank liner includes opposed dome shaped first and second endcaps each secured to the central circumferential region of the tank liner by a weld; and
b) an outer reinforcing layer disposed on an exterior portion of the tank liner.

13. A hybrid tank as recited in claim 12, wherein the first and second end caps are secured to the central circumferential region of the tank liner by a type of weld selected from the group consisting of a laser weld, a GMAW weld, and a submerged arc weld.

14. A hybrid tank as recited in claim 12, wherein the opposed dome shaped first and second endcaps are secured directly to each other by a type of weld selected from the group consisting of a laser weld, a GMAW weld, and a submerged arc weld.

15. A hybrid tank as recited in claim 12, wherein the tank liner includes a substantially cylindrical tube defining first and second rims wherein the opposed dome shaped first and second endcaps are secured to the first and second rims of the tube by welds of a type selected from the group consisting of a laser weld, a GMAW weld, and a submerged arc weld.

16. A hybrid tank as recited in claim 12, wherein each of the outer reinforcing layer and the tank liner has a wall thickness normal to an exterior surface of the tank liner, wherein the ratio of the wall thickness of the outer reinforcing layer to the wall thickness of the tank liner is at least 4.0 over a majority of the exterior portion of the tank liner.

17. A hybrid tank as recited in claim 16, wherein the wall thickness of the tank liner is substantially constant.

18. A hybrid tank as recited in claim 12, further comprising a protective jacket engaged around the outer reinforcing layer to protect the outer reinforcing layer, the protective jacket including an upper support rim, a lower support rim opposed to the upper support rim, and a jacket wall connecting the upper support rim to the lower support rim.

19. A hybrid tank as recited in claim 12, wherein the tank liner includes a metal selected from the group consisting of steel, stainless steel, aluminum, platinum, and titanium.

20. A hybrid tank for a high pressure vessel, comprising:
a) a metallic tank liner having opposed first and second end regions with a central circumferential region therebetween, wherein the tank liner includes opposed dome shaped first and second endcaps each secured to the central circumferential region of the tank liner by a laser weld;
b) an outer reinforcing layer disposed on an exterior portion of the tank liner, wherein each of the outer reinforcing layer and the tank liner has a wall thickness normal to an exterior surface of the tank liner, wherein the ratio of the wall thickness of the outer reinforcing layer to the wall thickness of the tank liner is at least 4.0 over at a majority of the exterior portion of the tank liner; and
c) a protective jacket engaged around the outer reinforcing layer to protect the outer reinforcing layer, the protective jacket including an upper support rim, a lower support rim opposed to the upper support rim, and a jacket wall connecting the upper support rim to the lower support rim.
